(19) United States
(12) Patent Application Publication
(10) Pub. No.: US 2020/0074915 A1
(43) Pub. Date: Mar. 5, 2020

(54) Aspect ratio adjustable display

(71) Applicant: Abdul Kamara, Zwolle (NL)

(72) Inventor: Abdul Kamara, Zwolle (NL)

(21) Appl. No.: 16/213,840

(22) Filed: Dec. 7, 2018

Related U.S. Application Data
(60) Provisional application No. 62/725,282, filed on Aug. 31, 2018.

(51) Int. Cl. G09G 3/20; G06F 1/16

(52) U.S. Cl. CPC G09G 3/2096; G06F 1/1601; G06F 2200/1612; G09G 2340/0442; G09G 2340/0407; G09G 2300/026

(57) ABSTRACT

Disclosed is a computer monitor capable of adding additional display resolution to the main display. This is achieved by means of side displays and without bezels in between the displays which comprise the whole display. Hereby this display is capable of alternating between multiple aspect ratios natively and setting up displays next to each other without bezels. The core components of the invention are: the main display, case, the side displays and monitor mounts, which generally speaking, are configured as follows: The side displays are hidden within the case and can be collapsed to be positioned next to the main display. The mounting arms allow the side displays to be positioned next to the main display so that the side displays can be connected to the main display and to be positioned back into the case when not in use. Thus, the device can be used to alternate between resolutions by adding additional resolution to the original resolution of the main display without bezels, thereby also changing the aspect ratio.

### CROSS-REFERENCE TO RELATED APPLICATION

This patent application is a continuation of U.S. provisional application Ser. No. 62/725,282, filed Aug. 31, 2018.

### BACKGROUND

### 1. Field of the Invention

The invention relates generally to a computer display and more particularly to a computer display which is capable of adjusting the aspect ratio thereof.

### 2. Background

Currently there are a number of ways to configure a multi-monitor setup. These configurations make it possible to connect multiple independent monitors to the same computer by duplicating the view across all monitors connected, or to extend the view across multiple monitors. But these configurations fail to achieve a seamless image because of the bezels in between the monitors. Solutions that make monitors thin still cause visual distraction or annoyance to some degree. Solutions to change the resolution and aspect ratio result in the display having to scale the image to a resolution which is not native to the screen, which may result in a distorted image or an image which doesn't occupy the full screen.

### SUMMARY

It is desirable to have a computer monitor that can alternate between different aspect ratios and thereby different resolutions natively, with the perk of occupying the whole screen in order to eliminate black edges at the sides of the display. It is also desirable to have a display which comprises multiple displays that can be arranged as if they were, and function as, one unified display without bezels in between. Furthermore, it is desirable to have a display which features a case in which displays can be housed when not in use. The disclosed device addresses each of these needs.

Disclosed is a computer monitor, which generally comprises the following components: a main display, side displays, case and monitor arms. These components are connected as follows: the case may house circuitry for power supply and for display interfaces which contain display connectors. The side displays are concealed by the main display, positioned into the case by default, and can be locked into position next to the main display by use of the monitor arms when positioned out of the case. When the side displays are configured and connected to the main display by use of one or several connectors on the sides of the side displays to the sides of the main display, the resolution and thereby the aspect ratio will change across the displays as if it were the native resolution. Thereby adding the resolution of the side displays to the main display according to the resolution of the side displays added to the main display and thereby forming a unified display.

When the side displays are disconnected from the main display the added resolution and thereby the alternated aspect ratio will change accordingly to how they were before the resolution was added by the side displays.

The device may also have one or more of the following: (1) Collapsible bezels of the displays which are concealed within a notch behind the display and which have a pin which holds the bezel in place but which allows it to be rotated around the pin's axis so that the bezel can be expanded; (2) A stand connected to the case which allows the display to be pivoted, tilted or adjusted in height, and which may have an opening for convenient cable management; (3) Pins for the monitor arms to enable them to swivel; (4) A mount attached to the back of the main monitor, which is fit and tilts around a mount attached to the stand which can slide up and down along the grooves of the stand; (5) Swivel mounts connected to the back of the side displays which are connected to the monitor arms by pins which allows the side displays to swivel and which attaches them to the monitor arms; (6) A notch within the case which allows the monitor arms to be retracted when they are collapsed, and a groove within that notch which allows protrusions of the monitor arm to slide back and forth but which restrains the monitor arms from sliding to far out of the case; (7) Grooves within the case which allow the hinges of the side display to slide in and out of the case; (8) A power socket, and buttons to configure display settings and a power button; and (9) venting holes which allows heat to escape the case.

The disclosed device is unique when compared to other known devices and solutions because it provides: (1) native support for alternation between different resolutions and thereby native support for alternation between different aspect ratios, by use of side displays which can be attached or detached from the main display, and in doing so also occupying the whole screen without black edges at the sides or an distorted image; (2) a display (in this embodiment the main display) which can provide video and electric power to other displays (in this embodiment the side displays) by use of connectors on the side of the display; and (3) bezels which are capable of being collapsed in order to more compact, and which are able to expand in order for all displays to align in height.

The disclosed device is unique in that it is structurally different from other known devices or solutions. More specifically, the device is unique due to the presence of: (1) integration of several displays which together form a unified display when connected, without bezels in between them; (2) male and female connectors on the sides of the displays to lock displays adjacent into position and to connect the displays together; (3) bezels that are capable of being collapsed, which can fit within a notch behind the display, when collapsed.

This disclosure will now provide a more detailed and specific description that will make reference to the accompanying drawings. The drawings and specific descriptions of the drawings, as well as any specific or alternative embodiments discussed, are intended to be read in conjunction with the entirety of this disclosure. The aspect ratio adjustable display may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE DRAWINGS

FIG. 1 is a perspective front view of a specific embodiment of this invention, showing expanded monitor arms with side displays connected to them and deployed next to the main display.

FIG. 2 is a perspective front view of the aforementioned display in FIG. 1, showing its monitor arms collapsed, and together with the side displays concealed within the case.

FIG. 3 is a perspective rear view of the aforementioned display of FIG. 1, showing expanded monitor arms with side displays connected to them and deployed next to the main display.

FIG. 4 is a front view of the aforementioned display of FIG. 1, showing expanded monitor arms with side displays connected to them and deployed next to the main display.

FIG. 5 is a rear view of the aforementioned display of FIG. 1, showing expanded monitor arms with side displays connected to them and deployed next to the main display.

FIG. 6 is a side view of the aforementioned display of FIG. 1, showing expanded monitor arms with side displays connected to them and deployed next to the main display.

FIG. 7 is a side view of the aforementioned display in FIG. 1, showing its monitor arms collapsed, and together with the side displays concealed within the case.

FIG. 8 is an exploded perspective rear view of an embodiment of the monitor arm and the accompanied side display of FIG. 1.

FIG. 9 is an exploded side view of an embodiment of the monitor arm and accompanied side display of FIG. 8.

FIG. 10 is a close-up view of a connector plug of the aforementioned side display of FIG. 1.

FIG. 11 is a close-up view of a connector of the aforementioned display in FIG. 1.

FIG. 12 is a close-up view of a groove within a notch of the case of the aforementioned display in FIG. 1.

FIG. 13 is a close-up view of a groove within the top (not shown) and bottom of the gap between the sides of the case of the aforementioned display in FIG. 1.

FIG. 14. is a bottom perspective view of the aforementioned display of FIG. 1, which shows specific display connectors.

### DETAILED DESCRIPTION

The present invention is directed to Aspect ratio adjustable display

In its most complete version the device comprises the following components: main display, side displays, monitor arms, collapsible bezels, case, display connectors, power socket, venting holes, buttons, pins, a stand mount, a swivel mount, stand swivel, case groove, stand grooves and stand.

These components are connected as follows: the main display is set up in such a way that it is built-in into the case which may house circuitry for power supply and display interfaces, which contain display connectors, a power socket and a power button. There are also buttons, which may also be connected to the circuitry to configure display settings. The case has a gap between the sides, which allows the monitor arms, which consist of a swivel and slider arm, and the side displays to be retracted when the monitor arms are collapsed. The swivel and the slider arm have a pin between them which allows the swivel arm to be swiveled into the desired position.

The swivel arm is connected to the swivel mount, which is connected to the back of the side display by another pin in between them, which allows the side display to swivel, and which attaches them to the monitor arm.

The case has a notch into it so that the monitor arms can be fit into the notch in such a way that the side displays can retract into the gap between the sides of the case when the monitor arms are collapsed. The notch also has a groove within it, which allows the protrusion of the monitor arms inside of the case to slide back and forth, but which prevents the monitor arm from sliding to far out of the case. The case also has grooves within it which allow the hinges of the side display to slide in and out of the case. The monitor arms, which are connected to the side displays, can be positioned next to the main monitor when they are extended and can be connected to the connectors of the main display by means of connector plugs on the side of the side displays to add additional resolution to the main display to alter the native resolution and thereby change the aspect ratio accordingly. When the side displays are no longer connected to the main display by disconnecting the connector plugs, the resolution and thereby the alternated aspect ratio will change accordingly to how they were before the additional resolution was added by the side displays. The stand provides support for the case and everything within or attached to it.

The stand also has so called stand grooves. The stand is connected to the back of the case through a mount which can slide up and down along the stand grooves so it can be positioned into the desired position, and which also has a mount connected to it which is the stand swivel. The stand swivel is connected to the back of the case which may be by a screw connection or any other connection. Through a swivel connection between the stand swivel and the stand mount, the case is capable of being pivoted, tilted or adjusted in height, and thereby, the displays and everything which is attached to the case, to be pivoted, tilted or adjusted around the axis of the stand mount.

The stand may also have an opening for convenient cable management. The case also has venting holes, which allow heat to escape.

Furthermore, the side displays may have collapsible bezels and also a pin which holds the bezel in the desired position but allows it to be rotated around the pin's axis.

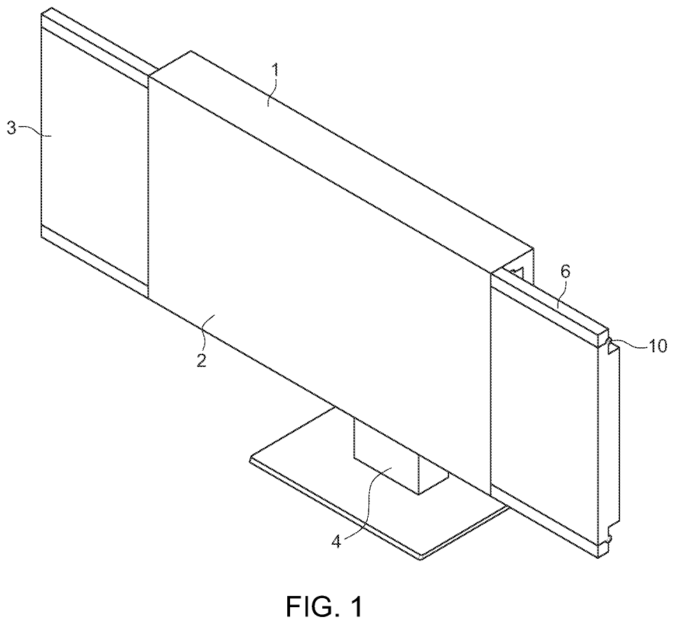

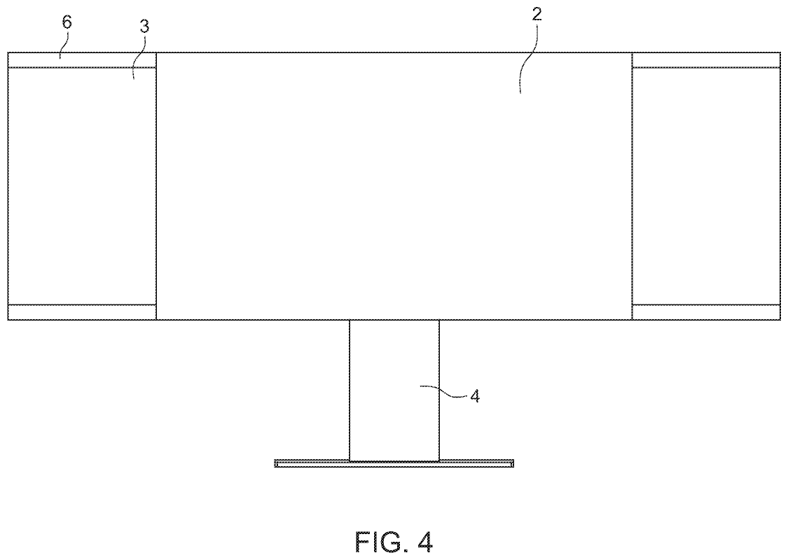

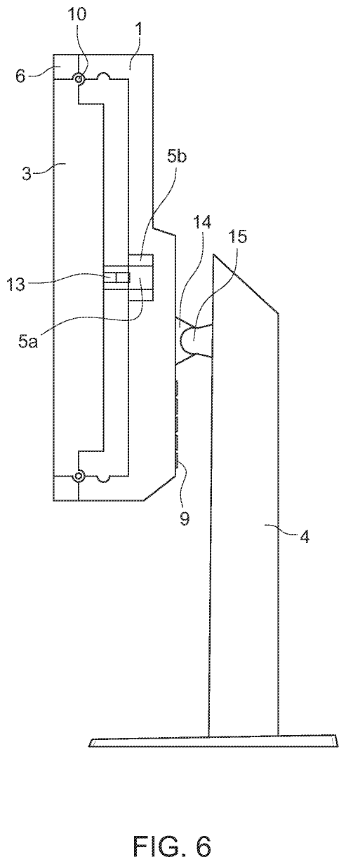

FIG. 1 is a perspective front view of an embodiment of the present invention comprising a case (1), best seen in FIG. 1, which has a display embedded into it at the front, the front view hereof is best seen in FIG. 4, the side view thereof is best seen in FIG. 6. This display, referred to as main display (2) is capable of displaying images and video like a regular computer display.

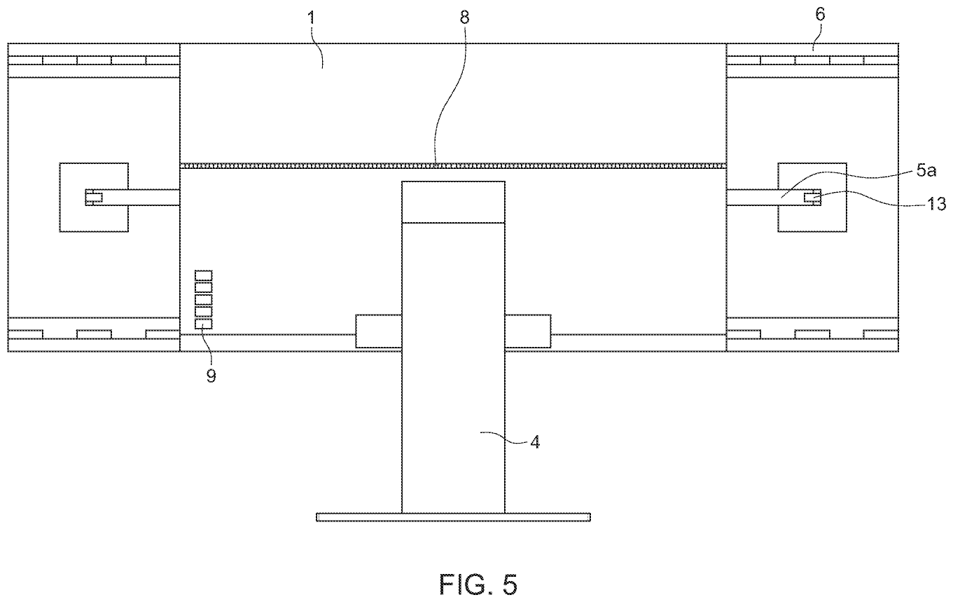

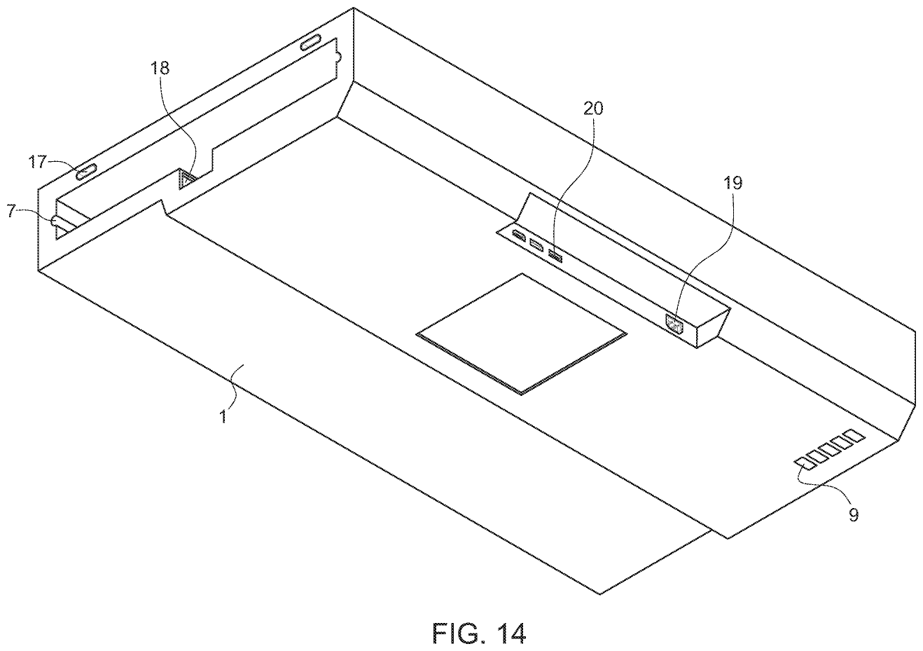

The case (1) may house circuitry (not shown) for power supply for the main display (2), side displays (3), display interfaces which contain display connectors (21), best seen in FIG. 14, a power socket (20) and a power button (9), best seen in FIG. 5, which may be the particular button labelled in the figure but is not confined to it and could be any other button.

The display connectors (21), best shown in FIG. 14, are also not confined to the display connectors shown, these are mere examples of display connectors which may be used in the present invention, other display connectors may be embodied in the present invention.

The buttons (9) which are not used as power button may also be connected to the circuitry (not shown) which may be housed by the case, and are used for configuring display settings.

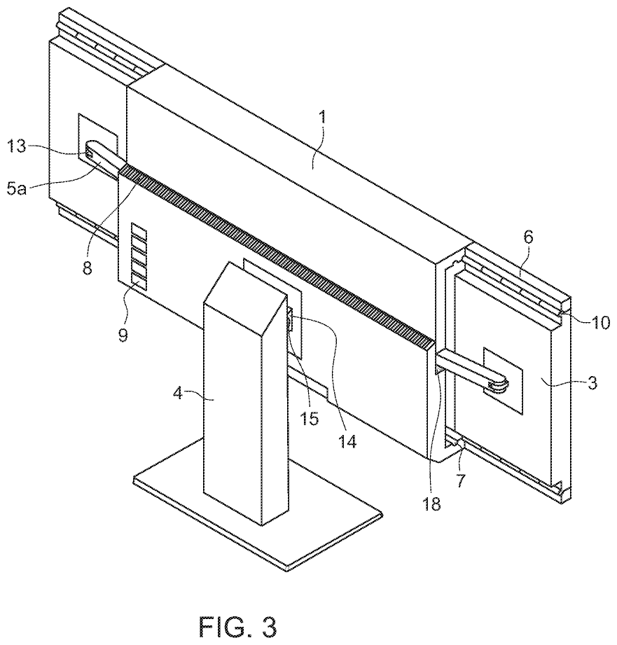

The case (1) may have venting holes (8) which allow heat to escape from the case, best seen in FIG. 3.

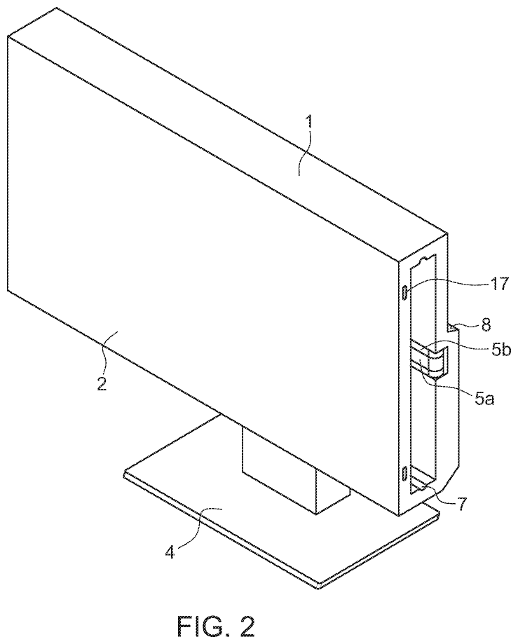

The case (1) has a gap between its sides, which has it shown in this embodiment of the invention with grooves at the top and bottom of the gap, referred to as hinge grooves (7), best seen in FIG. 2,

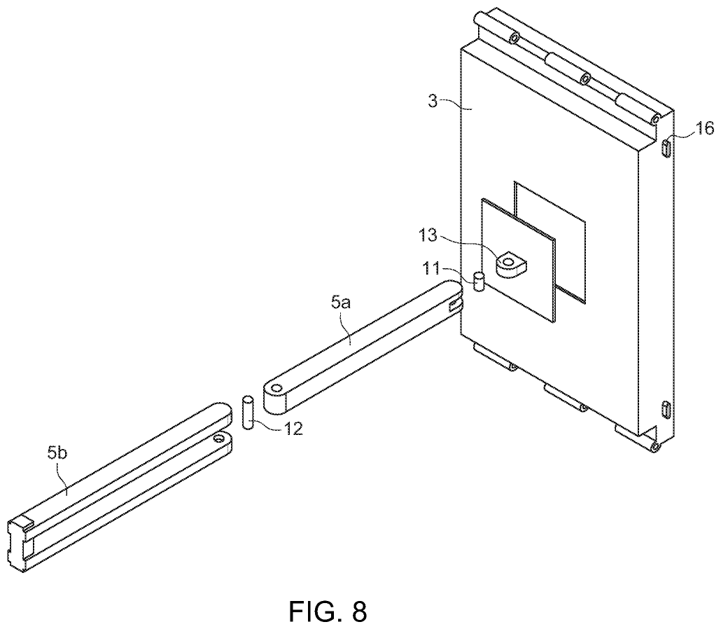

which allow the hinges at the top and the bottom of the side displays (3), best seen in FIG. 8, to slide in and out of the hinge grooves (7) or be in a stationary position within the hinge grooves (7).

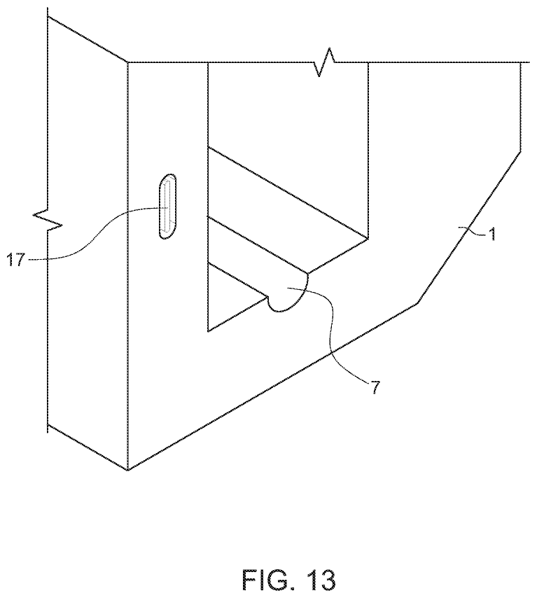

Best seen in FIG. 13, there is shown a close-up view of one of the hinge grooves (7).

The case (1) also has a notch into it which allows a monitor arm, which consist of two arms, the swivel arm (5a) and the slider arm (5b), best seen in FIG. 8, to be fit into the notch in the case (1), in such a manner that the side displays (3), can retract into the gap between the sides of the case when the monitor arms (5a) and (5b) are collapsed, and so that that they can get out of the case when the monitor arms (5a) and (5b) are expanded, best seen in FIG. 3.

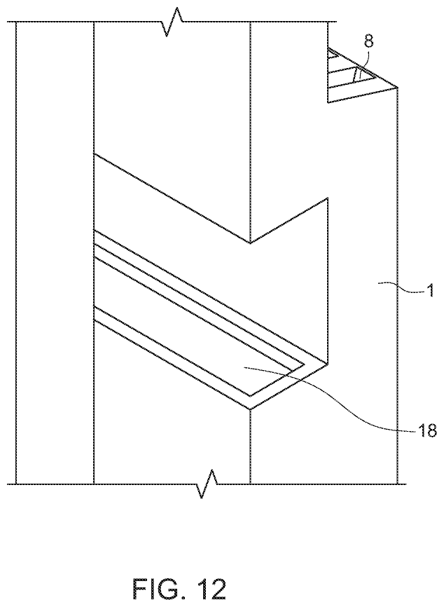

The notch within the case (1) also has a groove within it, referred to as case groove (18), best seen in FIG. 12, which allows the protrusion of the monitor arms, at one end of the slider arm (5b), best seen in FIG. 8, to slide back and forth within the case groove (18), but prevents the slider arm (5b) from sliding entirely out of the case (1).

The monitor arm, which consists of two arms mentioned earlier, swivel arm (5a) and slider arm (5b), and the side display, best seen in FIG. 8, are configured in the following manner: The side display (3) has a mount connected to it at the rear, which will be referred to as swivel mount (13), the connection between the side display (3) and the swivel mount (13) can be a screw connection (not shown) but is not restricted to such a connection.

The side displays (3) have collapsible bezels (6), best seen in FIG. 3, which can be expanded and collapsed.

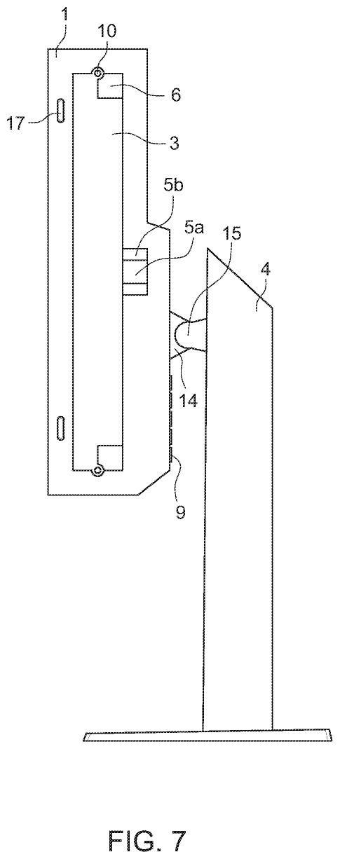

The collapsed configuration of the collapsible bezel (6) is best seen in FIG. 7. The expanded configuration of the collapsible bezel (6) is best seen in FIG. 6. in both figures there is shown a pin, referred to as hinge pin (10), which holds the bezel in the desired position but allows it to be rotated around the pin's axis.

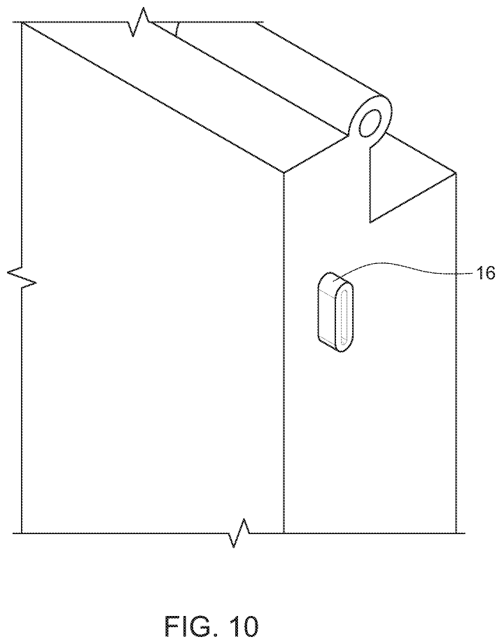

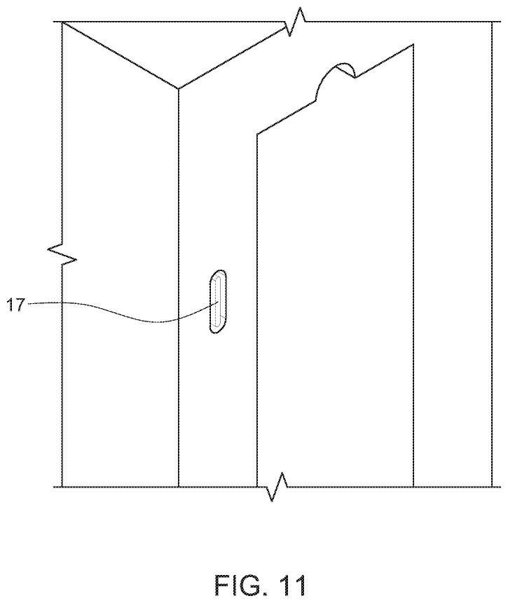

The side display (3) also has connector plugs (16), best seen in FIG. 10, at the side of the display to connect the side display (3) to the main display (2), via its connector (17), best seen in FIG. 11.

By mating the connectors (16) and (17), and thereby connecting the side displays (3) to the main display (2), the resolution of the side displays (3), connected to the main display (2), will be added to the resolution of the main display (2), and will form a resolution which is a combined resolution of the resolutions of the main display (2) and the side display (3), thereby not only alternating the resolution, but also the aspect ratio of the entire display, which comprises screens of the main display (2) and the side displays (3) together.

When a side display (3) is disconnected from the main display (2), by disconnecting the connector plugs (16), the resolution and thereby the alternated aspect ratio will change accordingly to the resolution before the additional resolution was added by the side displays (3).

The result of the main display (2) and the side displays (3) connected to each other can be best seen in FIG. 1.

As best seen in FIG. 8 is the following:

There is a pin, referred to as swivel pin (11) located between the swivel mount (13) and the swivel arm (5a), which allows the swivel mount (13), which has a side display (3) attached to it, to swivel so that the side display (3) can be configured into the desired position.

There is another pin, referred to as slider pin (12) between the swivel arm (5a) and the slider arm (5b), which allows the swivel arm (5a) to be swiveled into a desired position.

The slider arm (5b) can move back and forth along the case groove (18) within the notch of the case (1) mentioned earlier.

Both pins (11) and (12), together with the hinge pin (10) mentioned earlier, in addition to allowing the components attached to them to swivel, hold the components in place to ensure a desired position when positioned, and allow the components to revolve around the pin's axis.

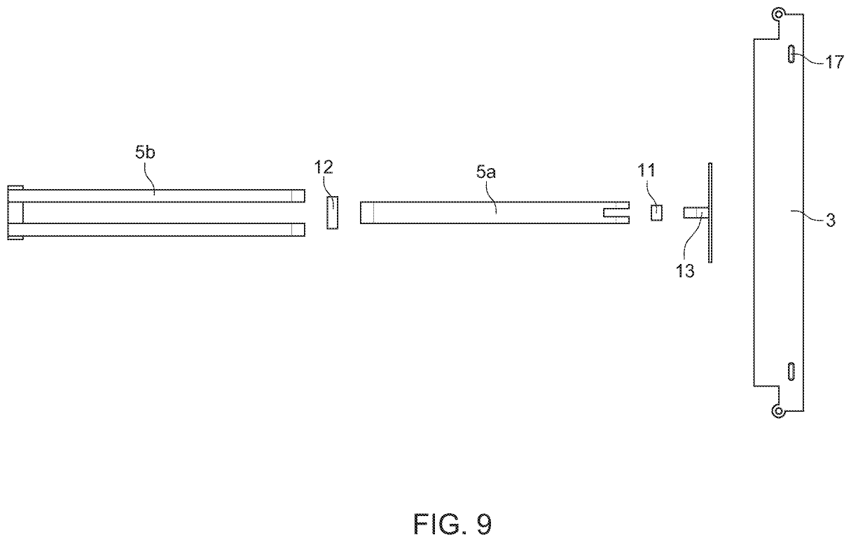

Best seen in FIG. 9 is an exploded side view hereof.

The stand (4), best seen in FIG. 2, provides support for the case (1) and everything within or attached to it.

The stand (4) has grooves, which will be referred to as stand grooves (not shown).

The stand (4) is connected to the back of the case (1) through a mount, which will be referred to as stand mount (15), best seen in FIG. 7.

The stand mount (15) can slide up and down along the stand grooves (not shown) and can be positioned into a desired position. The stand mount (15) also has a mount connected to it which will be referred to as stand swivel (14), best seen in FIG. 2.

The stand swivel (14) is connected to the back of the case (1), which may be by a screw connection (not shown) or any kind of connection.

It allows the case (1), and thereby, the displays (1) and (3) and everything which is attached to the case (1), to be pivoted, tilted or adjusted around the axis of the stand mount (15).

The stand (4) may also have an opening or hole for convenient cable management (not shown).

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

I claim:

1. An aspect ratio adjustable display comprising:
A case which preferably houses circuitry for power supply and for display interfaces which contain display connectors;
A main display which is built-in into said case and which is capable of displaying images and video like a regular computer display;
A side display which is concealed by said main display, which can be positioned into the case, and can be locked into position next to the main display;
A monitor arm which is capable of connecting said side display to said main display when positioned out of said case.

2. The aspect ratio adjustable display of claim 1, comprising multiple displays that can be arranged as if they were, and function as, one unified display without bezels in between.

3. The aspect ratio adjustable display of claim 1, wherein said monitor arm is connected to said side display further comprising a connector plug on the side which can be connected to a connector of said main display;

4. The monitor arm of claim 3, wherein said monitor arm consists of two arms;

5. The monitor arm of claim 3, wherein said monitor arm which consists of two arms comprises an arm which is capable of sliding back and forth and another which is capable of swiveling around its axis;

6. The aspect ratio adjustable display of claim 1, capable of changing aspect ratio, and thereby resolution, natively, by connecting and disconnecting said side display to and from said main display;

7. The aspect ratio adjustable display of claim 1, wherein video and electric power can be provided from the main display to the side display by said connector;

8. The aspect ratio adjustable display of claim 1, further comprising a bezel which can be collapsed and expanded according to preferences of the user or convenience;

9. The aspect ratio adjustable display of claim 1, further comprising a pin which holds the bezel in the desired position but allows it to be rotated around the pin's axis;

10. The case of claim 1, further comprising a notch within said case which allows the monitor arm to be retracted when it is collapsed;

11. The notch of claim 10, further comprising a groove within said notch which allows a protrusion of the monitor arm to slide back and forth;

12. The groove of claim 11, wherein the monitor arms are restrained from sliding out of the case by an edge;

13. The aspect ratio adjustable display of claim 1, wherein the case comprises grooves which allow the hinges of the side display to slide in and out of the case;

14. A method for adding resolution to a display, and thereby changing the aspect ratio, by use of a connector of another display, comprising:
Providing a main display and a side display with connectors;
Positioning said main display and said side display in such a manner that they are adjacent to each other;
Mechanically and electrically connecting said main display and side display to one another, by use of a connector on the side of the display, by doing this locking it into position.

15. The method of claim 14, further comprising:
Waiting for the displays to be initialized so that the displays may adjust their resolution, and thereby the aspect ratio, and display the correct image at the right moment.

16. A method for providing electric power from a display to another display by a connector, comprising:
Mechanically and electrically connecting the main display and side display of claim 14, by use of their respective connectors.

17. The method of claim 16, wherein the main display provides electrical power to the side display by use of its connector.
